(19) United States
(12) Patent Application Publication
(10) Pub. No.: US 2011/0180662 A1
(43) Pub. Date: Jul. 28, 2011

(54) LANDING GEAR

(75) Inventors: Flora Nardone, Napoli (NA) (IT); Giuseppe Carreras, Napoli (NA) (IT)

(73) Assignee: MAGNAGHI AERONAUTICA S.P.A., Napoli (NA) (IT)

(21) Appl. No.: 12/864,371

(22) PCT Filed: Jan. 26, 2009
(86) PCT No.: PCT/IB09/50302

§ 371 Date: Mar. 8, 2011

(30) Foreign Application Priority Data
Jan. 24, 2008 (IT) RM2008A000043

(51) Int. Cl. B64C 25/10; B64C 25/34; B64C 25/58

(52) U.S. Cl. 244/102 R

(57) ABSTRACT

A bogie-type landing gear for aircraft is provided. The landing gear includes at least one front wheel and at least one rear wheel connected to a beam, a rocking arm centrally and rotatably connected to said beam, and a shock absorbing element. The rocking arm ends and the shock absorbing element, which are distal to the wheels, are articulated on a lever element hinged on the aircraft frame, onto which an actuator assembly for rotating said lever element urges between a position in which the wheels are in an operative configuration and a position in which the wheels are retracted in the landing gear bay.

### FIELD OF INVENTION

The present invention refers to a landing gear for aircraft, of the “bogie” type, with double wheels in the front and in the back, in general comprising one or more front wheels and one or more rear wheels connected to a rocking beam, and at least a shock absorbing element.

### BACKGROUND

This kind of landing gear is frequently used in medium or large aircraft.

Similar landing gears are known, but they are quite heavy and require wide installation spaces for their structure and the system for retracting them in the nacelle.

Therefore, these two factors limit the use of this kind of landing gears, as these factors influence the vehicle performances.

### SUMMARY

The technical problem underlying the present invention is to provide an aeronautical landing gear allowing to overcome the above-mentioned drawbacks with reference to the known art.

Such problem is solved by a landing gear as above specified, characterized in that the rocking arm ends of the shock absorbing element which are distal to the wheels are articulated on a lever element hinged on the aircraft frame, onto which means for rotating said lever element acts between a position wherein the wheels have an operative configuration and a position wherein the wheels are retracted within the landing gear bay.

The use of the above-mentioned structure allows remarkable weight and size reductions.

### BRIEF DESCRIPTION OF THE DRAWINGS

A preferred exemplificative embodiment of such landing gear will be hereby described, only as a non-limiting example, with reference to the annexed figures, wherein

FIG. 1 is a perspective view of a landing gear according to the invention; and

FIG. 2 is a side view of the landing gear of FIG. 1, showing both the operative configuration of the landing gear and its retracted position.

### DETAILED DESCRIPTION OF THE PREFERRED EMBODIMENTS

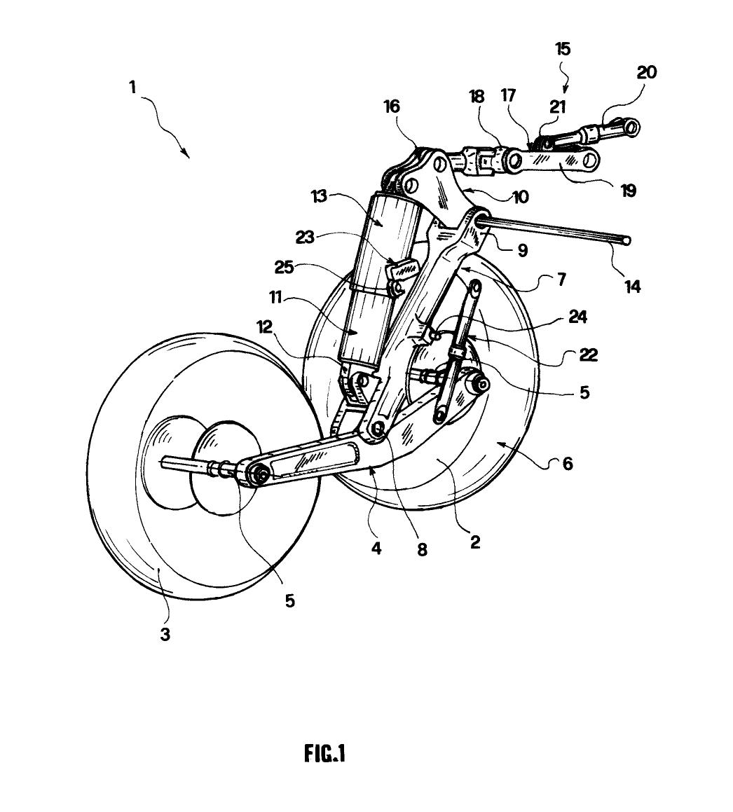

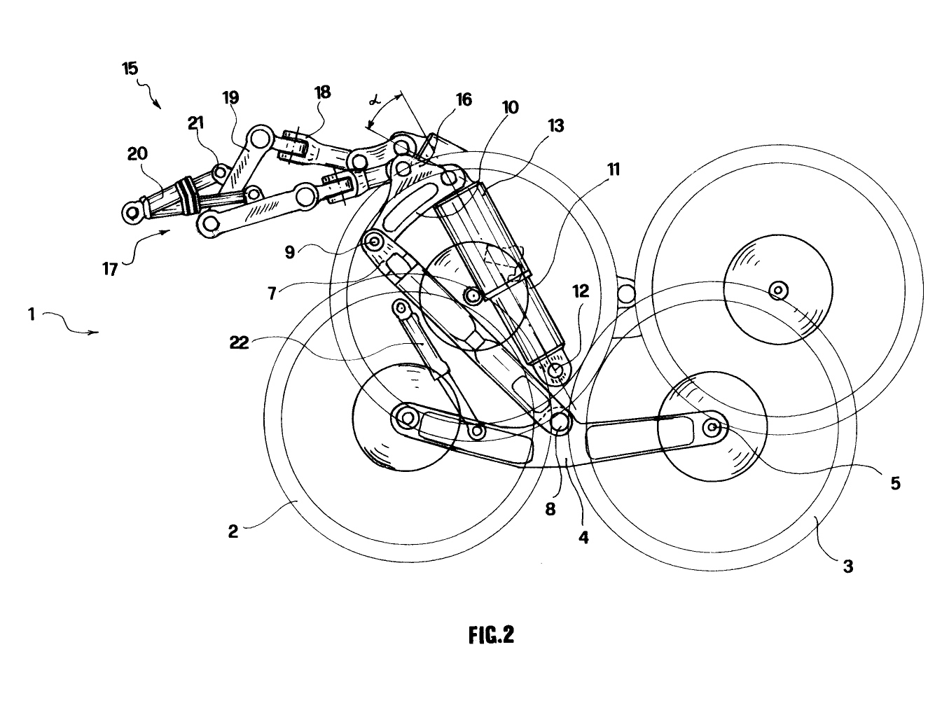

With reference to FIGS. 1 and 2, an aeronautical landing gear is overall shown with 1. It is of the so-called “bogie” type, and accordingly it has a pair of wheels, front 2 and rear 3, connected by a beam 4.

In the present exemplificative embodiment, the landing gear 1 has a single front wheel 2 and a single rear wheel 3, placed on the same side of the beam 4 and rotatably connected thereto at a respective hub 5.

Moreover, it is intended that each wheel 2, 3 will be provided with a suitable tire 6.

The wheels 2, 3 and the beam 4 are connected to the suspended masses of the aircraft by means of a rocking arm 7, which is rotatably connected to the beam 4 on a first hinge 8 substantially at the center of the beam 4.

The distal end 9 of the rocking arm 7 is instead articulated to a lever element 10, in turn hinged to the suspended mass with respect to the wheels 2, 3, i.e. the aircraft frame.

The linkage between the wheels 2, 3 and the suspended mass is also realized by a shock absorbing element 11, of the oleo-pneumatic kind.

In particular, the shock absorbing element 11 is connected to the rocking arm 7 on a second hinge 12 placed substantially next to said first hinge 8, in this example.

The other end 13 of the shock absorbing element 11 is instead articulated on said lever element 10.

The latter is placed according to the aircraft advancing direction during takeoff and landing. In particular, said first hinge and the end of the lever element onto which the rocking arm 7 is articulated are oriented towards the front or the bow of the aircraft.

The lever element 10 is articulated with the aircraft frame at a front end thereof onto which urges the articulated joint of the rocking arm 7 on a single poking position 14.

The shock absorbing element 11 is then connected to the lever element 10 on the other opposed end. The lever element 10, the shock absorbing element 11 and the rocking arm 7 realize an articulate triangle forming the linkage between the suspended masses, i.e. the aircraft, and the beam 4 with the wheels 2, 3.

Since such triangle would be undeformable if it were made of rigid elements, it comprises the shock absorbing element 11 which is capable of absorbing kinetic energy during landing, after contact between wheels 2, 3 and ground. Therefore, the triangle buckles by varying the length of the shock absorbing element 11.

On the lever element 10 an actuator assembly for rotating said lever element 10 acts between a position wherein the wheels 2, 3 are in an operative configuration and a position wherein the wheels 2, 3 are retracted in the landing gear bay, not shown. The means for rotating is overall shown with 15.

The actuator assembly 15 is articulated on the lever element 10 at an extension 16 thereof, placed next to the articulated joint of the shock absorbing element 11. The actuator assembly 15 is formed by an articulated arm 17 comprising a first portion 18 and a second portion 19 articulated by means of a cardanic element, said first portion 18 being connected to the lever element 10 and said second portion 19 being connected to the aircraft frame.

On the second portion 19 there is connected a maneuver hydraulic jack 20 at an intermediate articulated joint 21.

The retraction of the actuator 20 causes the rotation of the second portion 19, dragging up the first portion 18, the lever element 10 and the whole triangle to which it belongs.

In such way, the landing gear 1 is retracted, moving towards the front of the aircraft, lying on a vertical plane disposed along the aircraft advancing direction.

The dimensions of the landing gear depend principally on the dimensions of the shock absorbing element 11 and of the lever element 10, thus obtaining a considerable reduction of the overall dimensions inside the aircraft.

In FIG. 2, the retraction angle is highlighted and shown with α.

When the actuator 20 extends, the wheels 2, 3 are brought down until they reach an operative configuration. In this position, the shock absorbing element 11 is already placed in an optimal position in order to bear loads during landing, and no further supporting and strengthening elements are thus required, thus limiting the overall weight of the landing gear 1.

Anyhow, active and passive means for assuring the correct positioning and the locking of the landing gear 1 and the locking thereof in the landing configuration, as well as means for locking the landing gear when the aircraft is on the ground so as to avoid an erroneous retraction in the landing gear bay are provided.

The articulated arm 17 and the maneuver actuator 20 further extend frontally from the lever element, relative to the aircraft frame, thus without affecting the dimensions of the landing gear 1.

Moreover, the landing gear 1 has a hydraulic control device of the pitch angle 22 (pitch trimmer) placed on the front portion of the beam 4 and connected to the aircraft frame.

Although per se known in the art, such device performs the function of maintaining in a substantially horizontal and parallel to the runway position the beam 4, even if during landing the aircraft has a positive pitch, which would raise the front wheel 2.

In turn, as the device 22 reaches its complete extension, it is not fed hydraulically anymore.

Moreover, the landing gear 1 has stopping means 23 of the landing gear of the aircraft, normally installed on the aircraft's fuselage, where the landing gear is retracted in the bay.

To this regard, the rocking arm 7 is provided with a projecting pin 24 apt to cooperate with a hooking system 25, that could be hydraulically or mechanically unhooked by means of an apposite leverage.

To the above-described aeronautical landing gear, a person skilled in the art, in order to satisfy further and contingent needs, could effect several further modifications and variants, all however encompassed in the protective scope of the present invention, as defined by the appended claims.

What is claimed is:

1. A bogie-type landing gear (1) for an aircraft, the landing gear comprising: at least one front wheel (2) and at least one rear wheel (3) connected by a beam (4), a rocking arm (7) centrally and rotatably connected to said beam (4), and a shock absorbing element (11), wherein ends (7) of the rocking arm and of the shock absorbing element (11), which are distal to the wheels (2, 3), are articulated on a lever element (10) hinged on a frame of the aircraft, on which an actuator assembly for rotating (15) said lever element (10) acts between a position in which the wheels (2, 3) are in an operative configuration and a position in which the wheels (2, 3) are retracted in a landing gear bay of the aircraft.

2. Landing gear (1) according to claim 1, wherein said lever element (10) is articulated to the aircraft frame at a first end thereof onto which an articulated joint of the rocking arm (7) urges on an attachment point (14).

3. Landing gear (1) according to claim 2, wherein said lever element (10) is substantially placed along the aircraft advancing direction during landing, said first end being directed towards the bow and the landing gear (1) being a front retraction type.

4. Landing gear (1) according to claim 3, wherein said shock absorbing element (11) extends between an end of the lever element (10) opposed to said first end and the articulated joint on said rocking arm (7) next to an articulated joint on said beam (4).

5. Landing gear (1) according to claim 1, wherein said shock absorbing element (11) is of a cylinder-piston oleo-pneumatic kind.

6. Landing gear (1) according to claim 5, wherein the piston is articulated to the beam (4) and the cylinder is articulated to the lever element (10).

7. Landing gear according to claim 1, having a single front wheel (2) and a single rear wheel (3), placed on a same side of the beam (4).

8. Landing gear according to claim 3, further comprising a pitch compensator (22) placed on a front portion of the beam (4).

9. Landing gear (1) according to claim 2, wherein the actuator assembly for rotating (15) said lever element (10) is articulated on the lever element (10) at an extension (16) thereof next to an articulated joint of the shock absorbing element (11).

10. Landing gear (1) according to claim 2, wherein the actuator assembly for rotating (15) said lever element (10) has an articulated arm (17) comprising a first portion (18) and a second portion (19) articulated head to head, said first portion (18) being connected to the lever element (10) and said second portion (19) being connected to the aircraft frame.

11. Landing gear according to claim 10, wherein a retractile actuator (20) is rotatably connected to an intermediate articulated joint (21) on said second portion (19), for determining the rotation of the lever element (10).
